(19) United States
(12) Patent Application Publication
(10) Pub. No.: US 2026/0126172 A1
(43) Pub. Date: May 7, 2026

(54) BAFFLE COMPROMISING A LIGHTING SYSTEM

(71) Applicant: ARKTURA LLC, Carson, CA (US)

(72) Inventors: Ivan ARISTOV, Pasadena, CA (US); John JOHNSTON, Burbank, CA (US); Jesus VARGAS, Vista, CA (US); Terren LIN, Pasadena, CA (US)

(73) Assignee: ARKTURA LLC, Carson, CA (US)

(21) Appl. No.: 19/371,191

(22) Filed: Oct. 28, 2025

Related U.S. Application Data
(60) Provisional application No. 63/716,418, filed on Nov. 5, 2024.

(51) Int. Cl. F21V 33/00; E04B 9/04; E04B 9/34; F21V 7/00; F21Y 115/10

(52) U.S. Cl. CPC F21V 33/006; E04B 9/045; F21V 7/0033; E04B 9/34; F21Y 2115/10

(57) ABSTRACT

A baffle comprising a lighting system is disclosed. The baffle can comprise a first panel, a second panel, a cavity defined between the first panel and the second panel, the cavity being further defined by a support wall and an open end opposite the support wall, a strip comprising light emitting diodes attached to the support wall, and a lens engaged with the first panel and the second panel, wherein the lens is positioned intermediate the strip and the open end of the cavity.

### CROSS-REFERENCE TO RELATED APPLICATIONS

The present application claims the benefit of priority to U.S. Provisional Patent Application Ser. No. 63/716,418, filed Nov. 5, 2024, the entirety of which is incorporated herein by reference.

### FIELD OF THE INVENTION

The present invention relates to lighting systems for use with ceiling baffles and/or wall baffles, for example. That said, the devices disclosed herein could be configured for installation in any orientation and at any location in a room or space, including but not limited to ceilings, walls, floors, windows, archways, doorways, stairs, beams, columns, transoms, etc.

### BACKGROUND

In various instances, baffles are used within a building structure to absorb sound waves. When the baffles are suspended from a ceiling of the building structure, for instance, the baffles can may sometimes block ambient light. Disclosed herein are solutions that address challenges associated with absorbing sound waves while providing aesthetic lighting.

### SUMMARY

The present invention provides, in one form, a baffle comprising a first panel, a second panel, a cavity defined between the first panel and the second panel, wherein the cavity is further defined by a support wall and an open end opposite the support wall, a strip comprising light emitting diodes, wherein the strip is attached to the support wall, and a lens engaged with the first panel and the second panel, wherein the lens is positioned intermediate the strip and the open end of the cavity.

The present invention provides, in one form, a baffle comprising a first wall, a second wall, a chamber defined between the first wall and the second wall, wherein the chamber is further defined by a back wall and an opening opposite the back wall, an arrangement of light emitting diodes, wherein the arrangement of light emitting diodes is supported by the first wall and the second wall, and a diffusion plate positioned intermediate the first wall and the second wall, wherein the diffusion plate is positioned intermediate the arrangement of light emitting diodes and the opening.

The present invention provides, in one form, a baffle comprising a first wall, a second wall, a chamber defined between the first wall and the second wall, a light assembly, and a diffuser positioned intermediate the first wall and the second wall, wherein the diffuser is positioned intermediate the light assembly and the opening.

### BRIEF DESCRIPTION OF THE DRAWINGS

The features of the exemplary embodiments of the present invention will be described with reference to the following drawings, where like elements are labeled similarly, and in which:

FIG. 1 is a perspective view of a ceiling baffle including a lighting system in accordance with at least one embodiment;

FIG. 2 is another perspective view of the ceiling baffle of FIG. 1;

FIG. 3 is an exploded view of the ceiling baffle of FIG. 1;

FIG. 4 is another exploded view of the ceiling baffle of FIG. 1;

FIG. 4A is a detail view of the ceiling baffle of FIG. 1;

FIG. 5 illustrates a method of creating a slot in the ceiling baffle of FIG. 1;

FIG. 6 is a cross-sectional view of the ceiling baffle of FIG. 1;

FIG. 7 is a cross-sectional view of a ceiling baffle in accordance with at least one alternative embodiment;

FIG. 8 is a cross-sectional view of a ceiling baffle in accordance with at least one alternative embodiment;

FIG. 9 is a cross-sectional view of a ceiling baffle in accordance with at least one alternative embodiment;

FIG. 10 is a cross-sectional view of a lens of the ceiling baffle of FIG. 9;

FIG. 11 is a perspective view of a ceiling baffle assembly in accordance with at least one embodiment;

FIG. 12 is a perspective view of the ceiling baffle assembly of FIG. 11 in a second configuration;

FIG. 13 is a perspective view of a ceiling baffle assembly in accordance with at least one alternative embodiment;

FIG. 14 is a perspective view of a ceiling baffle of the ceiling baffle assembly of FIG. 13 illustrated with components removed for the purpose of illustration;

FIG. 15 is a perspective view of a ceiling baffle in accordance with at least one alternative embodiment illustrated with components removed for the purpose of illustration;

FIG. 16 is a bottom view of a ceiling baffle in accordance with at least one alternative embodiment;

FIG. 17 is a plan view of a baffle attached to a wall in accordance with at least one embodiment;

FIG. 18 is a perspective view of a ceiling baffle in accordance with at least one alternative embodiment; and

FIG. 19 is a bottom view of the ceiling baffle of FIG. 18.

Parts given a reference numerical designation in one figure may be considered to be the same parts where they appear in other figures without a numerical designation for brevity unless specifically labeled with a different part number and described herein.

### DETAILED DESCRIPTION

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

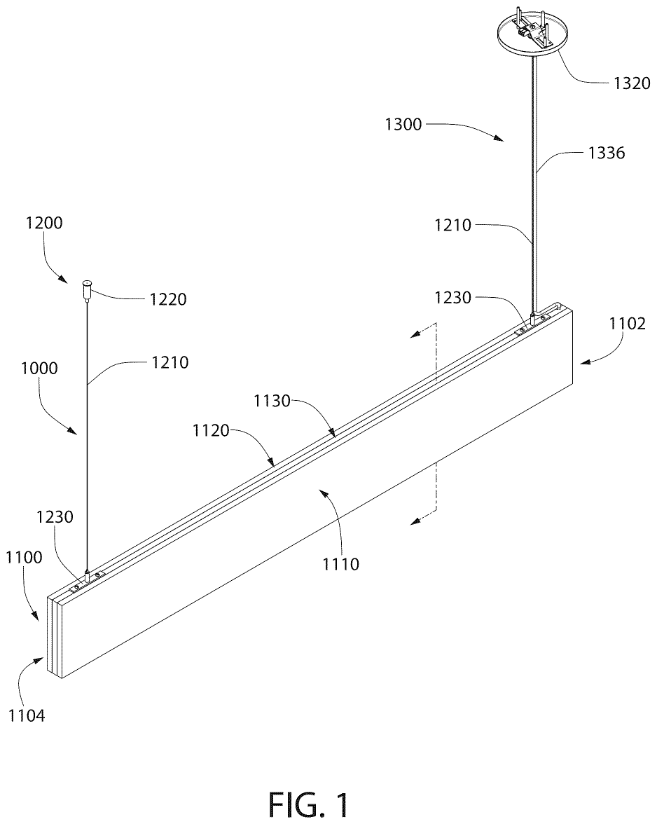

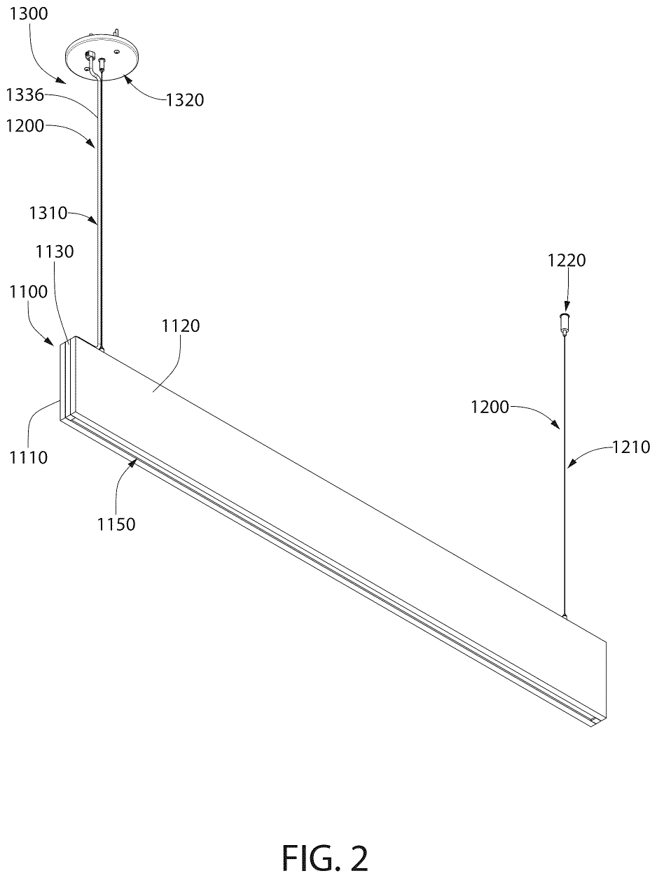

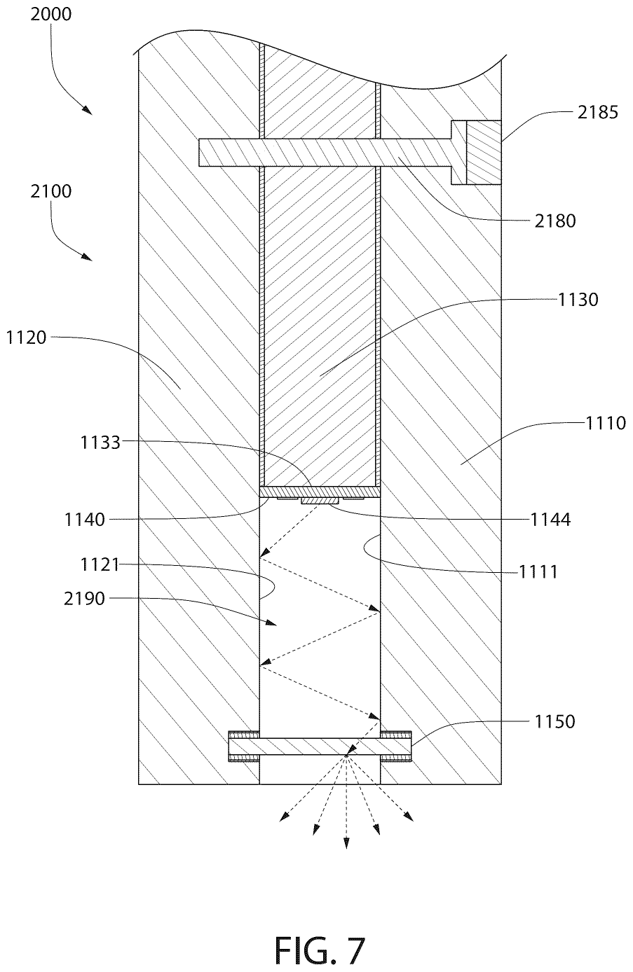

A baffle assembly 1000 is illustrated in FIGS. 1-6. Referring primarily to FIGS. 1-4, the baffle assembly 1000 comprises a baffle 1100, hangers 1200 configured to suspend the baffle 1100 from a ceiling, and a power supply 1300. The baffle 1100 comprises a first panel 1110, a second panel 1120, and an intermediate panel 1130 positioned intermediate the first panel 1110 and the second panel 1120. The first panel 1110 and the second panel 1120 are attached to the intermediate panel 1130 by one or more adhesives. That said, one or more fasteners can be used to attach the first panel 1110 and the second panel 1120 to the intermediate panel 1130. FIG. 7, for example, depicts a baffle assembly 2000 comprising a baffle 2100 including a first panel 1110, a second panel 1120, and an intermediate panel 1130 that are held together by one or more fasteners 2180. The fasteners 2180 can comprise any suitable fasteners, such as screws, for example. In various instances, the fasteners 2180 can create a hole in the first panel 1110 and/or the second panel 1120 which can be concealed, or at least filled, by a felt plug 2185 that is inserted into each hole. In various embodiments, the first panel 1110, the second panel 1120, and the intermediate panel 1130 are press-fit together.

Referring again to FIGS. 1-4, each hanger 1200 comprises a cable 1210, a connector 1220 configured to attach the cable 1210 to the ceiling, and a mount 1230 attached to the intermediate panel 1130 of the baffle 1100. In such an arrangement, the weight of the intermediate panel 1130 is carried by the cable 1210 without being transmitted through an adhesive interface, for example. In various other embodiments, the mount 1230 can be attached to the first panel 1110, the second panel 1120, and/or the intermediate panel 1130. In at least one other embodiment, the cable 1210 can comprise a rod, for example. The power supply 1300 comprises a power wire 1310 in communication with a power source, such as an electrical grid, for example, and a connector 1320 configured to be attached to the ceiling. In various embodiments, the power wire 1310 comprises a brass or copper core, for example, and an insulation jacket comprised of one or more polymers extending around the copper core. The power wire 1310 further comprises an end 1337 that extends through an opening 1137 defined in the intermediate panel 1130 that is electrically coupled to a strip 1140 of light emitting diodes (LEDs) in the baffle 1100, as discussed further below.

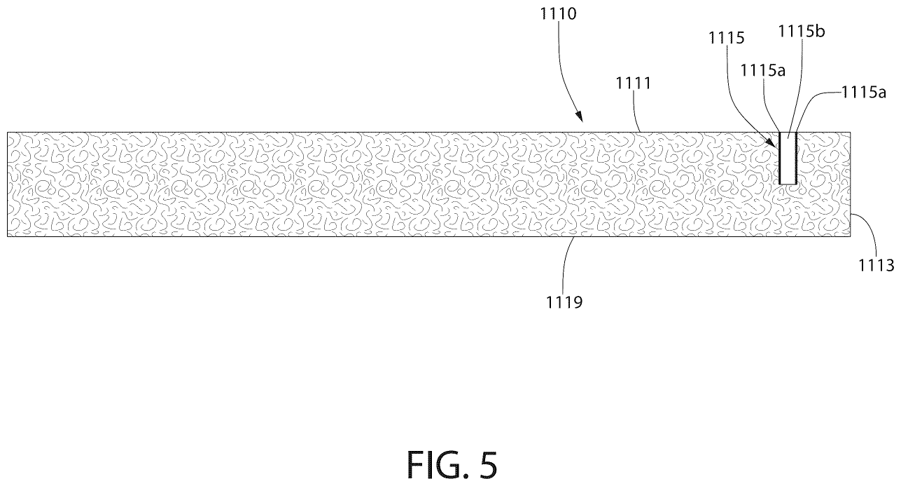

Further to the above, the first panel 1110 is comprised of felt, for example, but could be comprised of any suitable material. In various instances, the felt is comprised of natural and/or synthetic fibers, for example. In various instances, referring to FIG. 5, the fibers are formed into a sheet by one or more matting, condensing, and/or pressing processes, for example. The felt sheet can then be modified to create the first panel 1110. For instance, one or more grooves, slots, and/or score marks, for example, can be created in the felt sheet. In various instances, referring to FIG. 5, a longitudinal slot 1115 is created in the felt sheet by a first operation in which two longitudinal score lines 1115a are created in one side of the felt sheet and a second, subsequent, operation in which a channel 1115b is engraved between the score lines 1115a. In at least one instance, the first operation and/or the second operation can be performed with a heated instrument and/or with an instrument having a sharp edge, for example. In various embodiments, the felt sheet has a thickness that is the thickness of the first panel 1110. In at least one such embodiment, the first panel 1110 has an inner side 1111, an outer side 1119, and a constant, or an at least substantially constant, thickness between the inner side 1111 and the outer side 1119. In other embodiments, the felt sheet is folded to create the first panel 1110. In at least one such embodiment, the felt sheet is scored and then folded along the score marks. Moreover, in at least one such embodiment, the first panel 1110 can have an inner sound-dampening cavity defined therein. The above being said, the first panel 1110 can be created in any suitable manner, be comprised of any suitable material, and can have any suitable configuration.

Further to the above, the second panel 1120 is comprised of a felt sheet having an inner side 1121, an outer side 1129, and a constant, or an at least substantially constant, thickness between the inner side 1121 and the outer side 1129 and can be created in any suitable manner, such as those described above in connection with the first panel 1110, for example. Also further to the above, the intermediate panel 1130 is comprised of a felt sheet having two lateral sides and a constant, or an at least substantially constant, thickness between the two lateral sides and can be created in any suitable manner, such as those described above in connection with the first panel 1110, for example. The above being said, the second panel 1120 and the intermediate panel 1130 can be comprised of any suitable material and can have any suitable configuration.

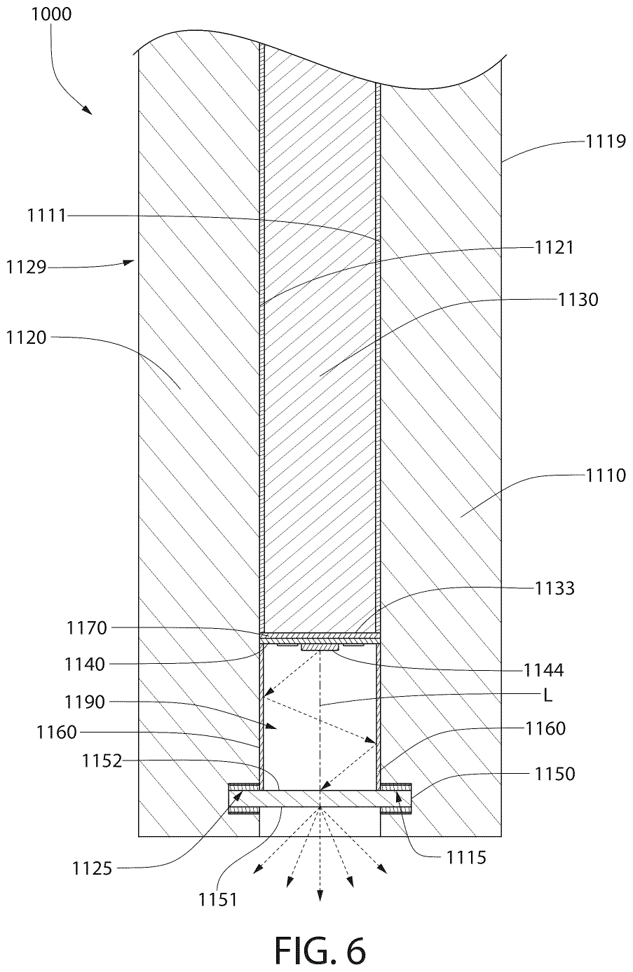

Further to the above, the intermediate panel 1130 comprises a first longitudinal end 1132 and a second longitudinal end 1134 positioned opposite the first longitudinal end 1132. The intermediate panel 1130 further comprises a cut-out, or recess, 1136 extending between the first longitudinal end 1132 and the second longitudinal end 1134. Referring primarily to FIG. 6, a cavity, or chamber, 1190 is defined between the first panel 1110 and the second panel 1120 along the length of the recess 1136. The chamber 1190 is further defined by a back side, or end, enclosed by a support wall 1133 of the intermediate panel 1130 and an open side, or end, opposite the back side. The baffle 1100 further comprises a metal substrate 1170 attached to the support wall 1133 that provides support to the strip 1140 of LEDs, mentioned above. In various embodiments, the metal substrate 1170 is attached to the support wall 1133 by one or more adhesives and the strip 1140 is attached to the metal substrate 1170 by one or more adhesives. In addition to or in lieu of an adhesive, the metal substrate 1170 can be attached to the support wall 1133 by one or more fasteners and the/or the strip 1140 can be attached to the metal substrate 1170 by one or more fasteners. The metal substrate 1170 can be comprised of an aluminum plate or sheet metal, for example, and/or a metallized strip comprising a substrate and one or more metals electroplated on the substrate, for example. In various embodiments, the metal substrate 1170 is comprised of a reflective material. In various alternative embodiments, the baffle 1100 does not comprise the metal substrate 1170. In at least one such embodiment, the strip 1140 of LEDs is directly attached to the felt of the support wall 1133.

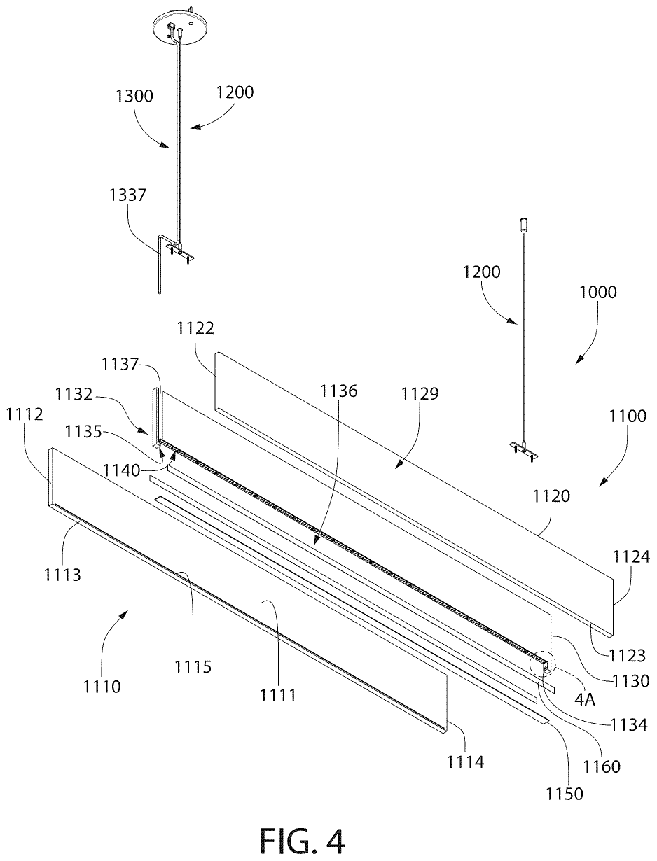

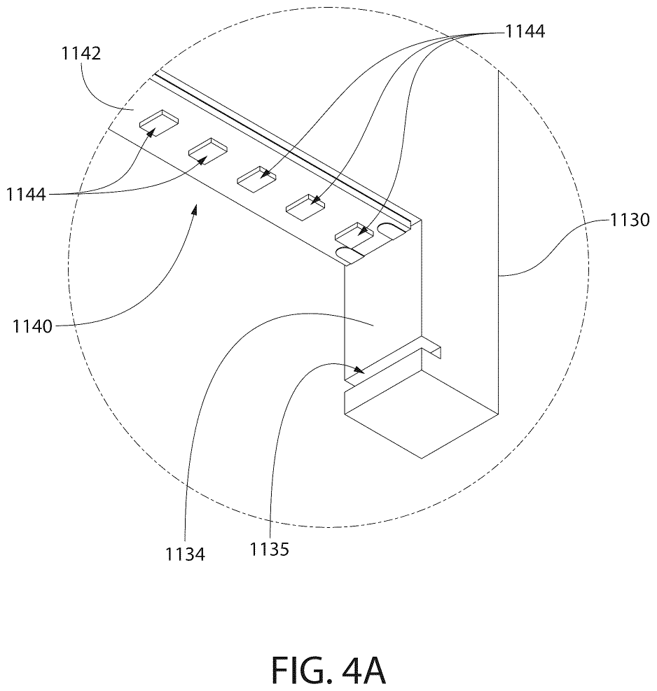

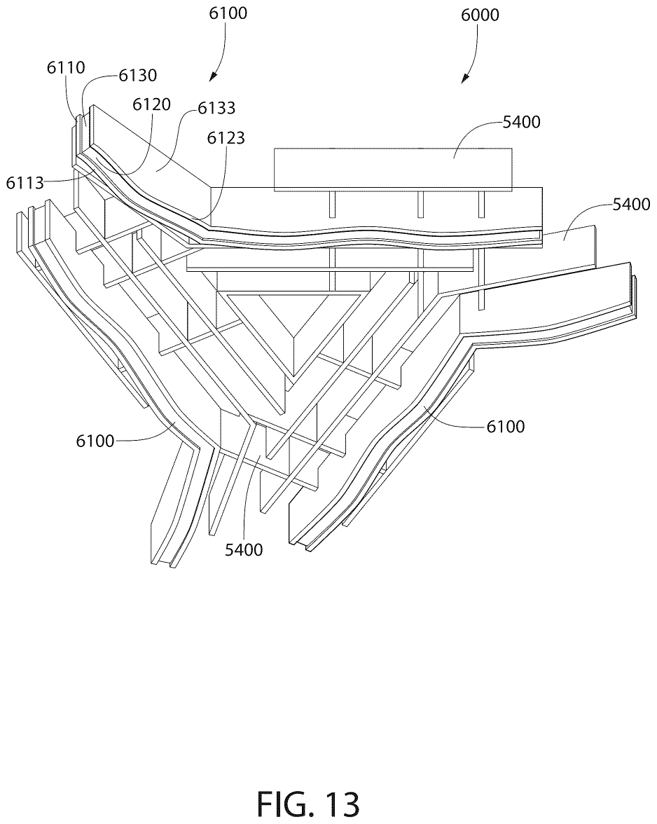

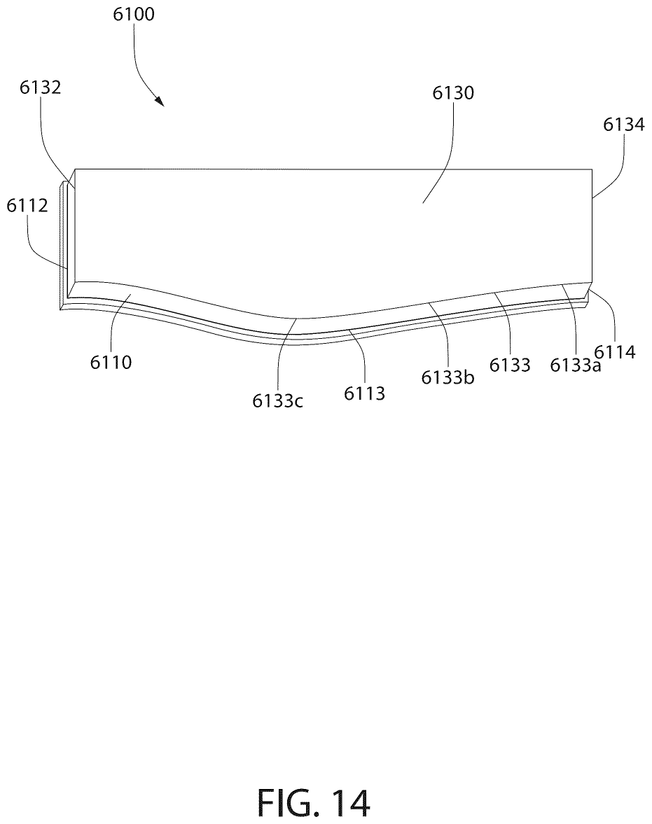

Further to the above, referring primarily to FIGS. 4A and 6, the strip 1140 of LEDs comprises a backing, or substrate, 1142 and LEDs 1144 mounted to the substrate 1142. The substrate 1142 is comprised of flexible materials. In various embodiments, the substrate 1142 is at least partially comprised of a non-conductive, or an at least substantially non-conductive, flexible substrate such as polyimide, polyetheretherketone (PEEK), and/or polyester, for example. The substrate 1142 also comprises one or more electrical traces, or power circuits, embedded within a flexible layer and/or positioned between two flexible layers of the substrate 1142. In at least some instances, one or more of the electrical traces can be present on, or printed on, the outer surface of the substrate 1142. In any event, the LEDs 1144 mounted on the substrate 1142 are in electrical communication with the electrical traces. As a result of the flexibility of the substrate 1142, the strip 1140 can conform to, or match, the profile, or contour, of the support wall 1133. In the embodiment depicted in FIGS. 1-6, the support wall 1133 is planar. More specifically, the support wall 1133 extends within a plane defined between the first longitudinal end 1132 and the second longitudinal end 1134 of the intermediate panel 1130. Other embodiments, however, are envisioned in which the support wall 1133 is contoured between the first longitudinal end 1132 and the second longitudinal end 1134. One such embodiment is illustrated in FIGS. 13 and 14, discussed further below. In such embodiments, the flexible strip 1140 can have the same contour as the contoured support wall 1133

In various alternative embodiments, further to the above, the strip 1140 can be rigid. In at least one such embodiment, the substrate 1142 of the strip 1140 comprises rigid non-conductive, or at least substantially non-conductive, layers comprised of fiberglass and/or composite epoxy, for example. A layer can be considered substantially non-conductive when any power loss and/or signal loss through the layer is negligible or ignorable. Similar to the flexible layers discussed above, electrical traces or copper circuits can be positioned within and/or between the rigid layers. In at least some instances, one or more of the electrical traces can be present on, or printed on, the outer surface of the substrate 1142. In various embodiments, the strip 1140 can comprise both rigid portions and flexible portions. In at least one such embodiment, for example, the rigid portions of the strip 1140 can be attached to planar portions of the support wall 1133 and the flexible portions of the strip 1140 can be attached to contoured portions of the support wall 1133.

Regardless of whether the strip 1140 is flexible and/or rigid, the strip 1140 can comprise one or more LED driver circuits configured to control the LEDs 1144. In at least one such embodiment, the power supply 1300 can also comprise a signal wire that provides a control signal from a controller, processor, or control system to a signal circuit extending through the substrate 1142. In various embodiments, the LED driver circuits can comprise one or more microchips that control the color and/or intensity of the LEDs 1144 in response to the control signal received from the controller, processor, or control system. In at least one such embodiment, at least one of the pins of each microchip is electrically coupled to the signal circuit extending through the substrate 1142, at least one of the pins of each microchip is electrically coupled to the power circuit extending through the substrate 1142, and at least one of the pins of each microchip is electrically coupled to a terminal of at least one of the LEDs 1144. In various instances, each microchip can have four output pins which simultaneously present four different control voltages to an LED 1144 that correspond to the red light (R), green light (G), blue light (B), and white light (W) emitted by the LED 1144. As a result, the microchips can control the RGB light colors emitted by the LEDs 1144, for example, to control the overall light color emitted by the baffle 1100. Moreover, each LED 1144 can comprise one or more pairs of LEDs, or each LED 1144 can comprise a single LED. Moreover, each LED 1144 can comprise a multicolor LED or a single color 1144. The above being said, any suitable type of light, such as incandescent lights, for example, can be used in addition to or in lieu of the LEDs 1144.

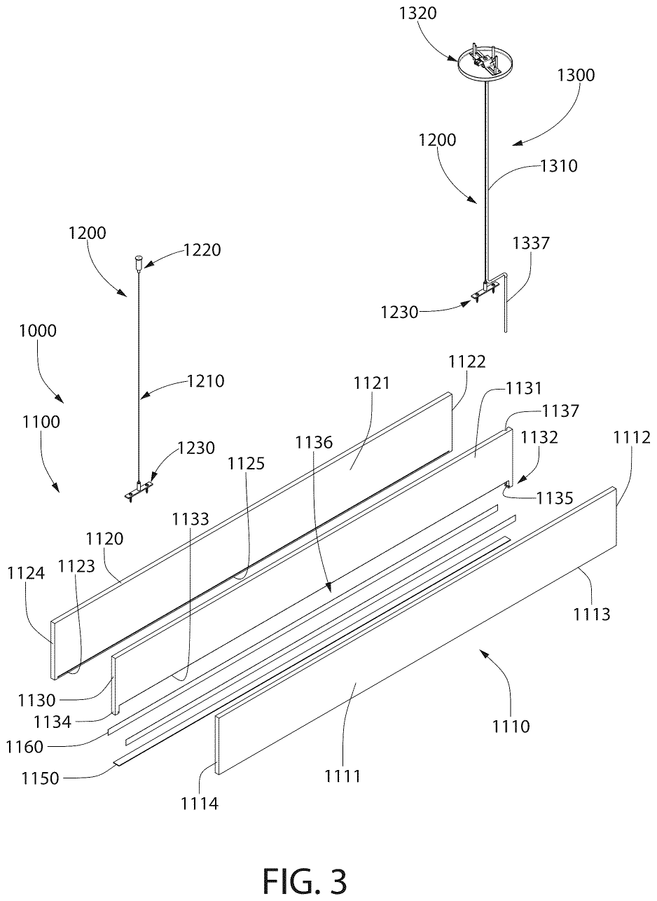

Referring again to FIGS. 3, 4, and 6, the baffle 1100 further comprises a lens 1150. The lens 1150 is partially positioned within a first longitudinal retention slot 1115 defined in the first panel 1110 and a second longitudinal retention slot 1125 defined in the second panel 1120. The first retention slot 1115 extends between the first longitudinal end 1112 and the second longitudinal end 1114 of the first panel 1110 and comprises one or more sidewalls that support a first lateral edge of the lens 1150 and, similarly, the second longitudinal slot 1125 extends between a first longitudinal end 1122 and a second longitudinal end 1124 of the second panel 1120 and comprises one or more sidewalls that support a second, or opposite, lateral edge of the lens 1150. Similarly, referring to FIG. 4A, the ends of the intermediate panel 1130 comprise end retention slots 1135 defined therein which receive and support the ends of the lens 1150. The lens 1150 comprises an outwardly-facing first side 1151, an inwardly-facing side 1152, and a thickness defined between the first side 1151 and the second side 1152. In various instances, the thickness of the lens 1150 is such that the lens 1150 is closely received between the sidewalls of the first retention slot 1115, closely received between the sidewalls of the second retention slot 1125, and closely received between the sidewalls of each end retention slot 1135. In at least one instance, the lens 1150 is press-fit between the sidewalls of the first retention slot 1115 and press-fit between the sidewalls of the second retention slot 1125. In such embodiments, relative movement between the lens 1150 and the first and second panels 1110 and 1120 is prevented, or at least inhibited. In various embodiments, a compressible material is positioned between the lens 1150 and the sidewalls of the first and second retention slots 1115, 1125 that is configured to prevent, or at least inhibit, relative movement between the lens 1150 and the first and second panels 1110 and 1120. In various embodiments, the compressible material can comprise a seal that prevents, or at least inhibits, the ingress of dust and/or water.

Further to the above, the first side 1151 of the lens 1150 is flat, or at least substantially flat. Similarly, the second side 1152 of the lens 1150 is flat, or at least substantially flat. A side can be substantially flat when it appears flat to an observer. The first side 1151 extends in a first plane and the second side 1152 extends in a second plane. The first plane and the second plane are parallel, or at least substantially parallel. The first and second planes can be substantially parallel when they appear parallel to an observer. In such embodiments, the lens 1150 has a constant, or an at least substantially constant, thickness thereacross. The thickness can be substantially constant when it appears constant to an observer. In various embodiments, the lens 1150 can comprise a plate. In various alternative embodiments, the first side 1151 and/or the second side 1152 of the lens 1150 are curved. In at least one such embodiment, the first side 1151 and/or the second side 1152 comprise a convex and/or concave configuration. Regardless of the configuration of the lens 1150, the lens 1150 can be comprised of plastic, such as polycarbonate, for example, and configured to diffuse the light emitted by the strip 1140 of LEDs, as discussed further below. In at least one embodiment, the lens 1150 is curved between the first panel 1110 and the second panel 1120. In at least one such embodiment, the lens 1150 is curved relative to an axis extending between the first panel 1110 and the second panel 1120.

Further to the above, referring again to FIG. 6, the LEDs 1144 are configured to emit light which is transmitted through the cavity 1190 defined between the first panel 1110, the second panel 1120, and the intermediate panel 1130 and then through the lens 1150. The light emitted by the LEDs 1144 is not unidirectional; rather, the light produced by the LEDs 1144 can be emitted through a wide range, such as 60 degrees, 90 degrees, 120 degrees, or 150 degrees, for example. Depending on the length of the cavity 1190 to the first side 1151 of the lens 1150, i.e., length L, the light emitted by the LEDs 1144, absent more, may contact and, at least in part, reflect off the inner side 1111 of the first panel 1110 and the inner side 1121 of the second panel 1120 one or more times which can change the net color of the light before it passes through the lens 1150. The baffle 1100, however, has reflective plates 1160 positioned against the inner side 1111 of the first panel 1110 and the inner side 1121 of the second panel 1120 which can reduce the amount of light absorbed by the first panel 1110 and the second panel 1120 and, as a result, limit the change in the net color of the light emitted by the LEDs 1144. The reflective plates 1160 can be comprised of aluminum and/or a reflective plastic, for example, and/or can be electroplated with one or more metals, such as nickel, for example. The reflective plates 1160 can be attached to the first panel 1110 and the second panel 1120 using one or more adhesives and/or one or more fasteners, for example. In various embodiments, the reflective plates 1160 extend from the strip 1140 to the lens 1160 along the entire lateral sides of the cavity 1190. In other embodiments, the reflective plates 1160 extend less than the entire distance between the strip 1140 and the lens 1160. Moreover, embodiments are envisioned in which a baffle does not include such lateral reflective plates, such as baffle 2100 illustrated in FIG. 7. Notably, the baffle 2100 has a cavity 2190 that is longer than the cavity 1190, the length of which being selected, as well as the transverse width of the cavity 1190, such that the light emitted from the lens 1150 is a desired net color after passing through the cavity 2190 and the lens 1150.

In various embodiments, further to the above, the reflective plates 1160 can have a color which is selected to intentionally change the net color of the light emitted by the lens 1150. In at least one such embodiment, the reflective plates 1160 can be painted one or more colors which produces a desired net color of the light emitted by the lens 1150.

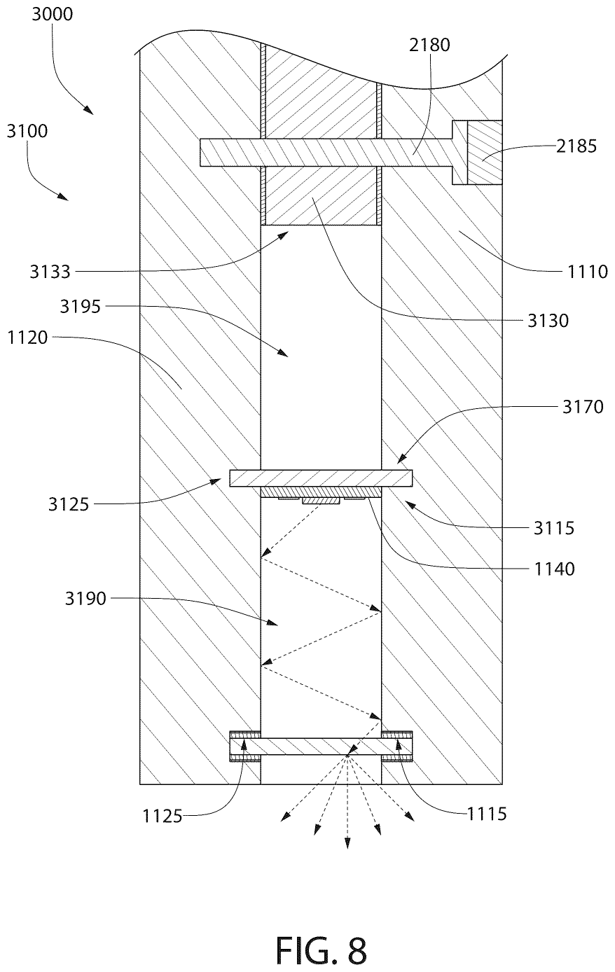

As discussed above in connection with the baffle 1100, referring to FIG. 6, the strip 1140 is supported by the intermediate panel 1130. This is also the case with the baffle 2100 depicted in FIG. 7. Such an arrangement, however, can constrain the range of positions in which the strip 1140 can be positioned between the first panel 1110 and the second panel 1120 relative to the lens 1150. Referring to FIG. 8, however, the light strip 1140 of a baffle 3100 is not supported by an intermediate panel 3130. Rather, the strip 1140 is attached to and supported by a sheet metal strip 3170 that is directly attached to and supported by the first panel 1110 and the second panel 1120. To this end, the first panel 1110 comprises a longitudinal retention slot 3115 defined therein in which a first lateral side of the sheet metal strip 3170 is received and, similarly, the second panel 1120 comprises a longitudinal retention slot 3125 defined therein in which a second, or opposite, lateral side of the sheet metal strip 3170 is received. Owing to this arrangement, a cavity 3195 is defined between the backside of the sheet metal strip 3170 and a bottom wall 3133 of the intermediate panel 3130. In various instances, the position of the retention slots 3115 and 3125 relative to the lens 1150 can be selected to provide a desired length for a light chamber 3190 between the strip 1140 and the lens 1150.

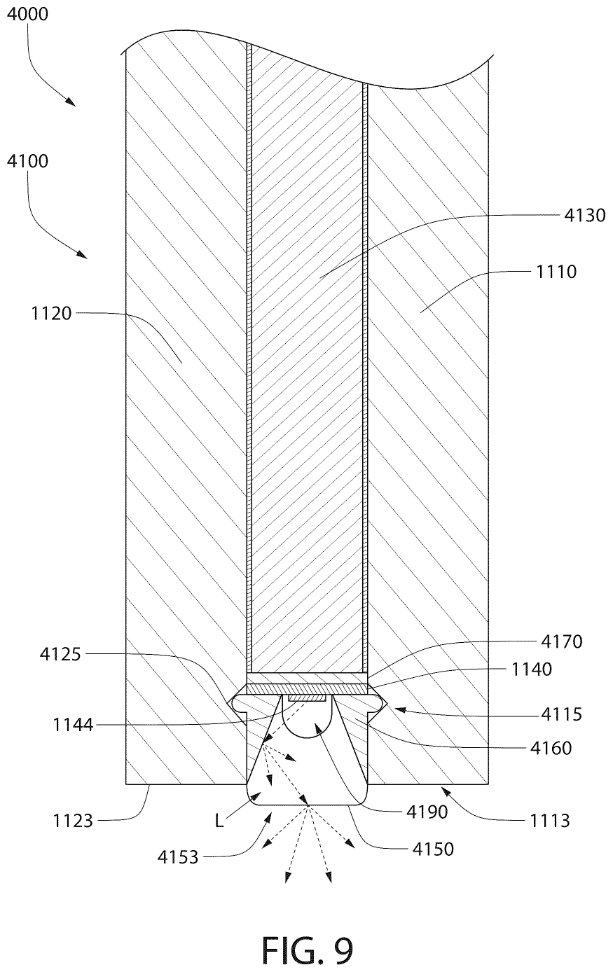

A baffle 4100 is illustrated in FIG. 9. The baffle 4100 is similar to the baffles 1100, 2100, and 3100 in many respects. Similar to the baffles 1100, 2100, and 3100, the baffle 4100 comprises a first panel 1110 and a second panel 1120. The baffle 4100 further comprises an intermediate panel 4130 positioned between and attached to the first panel 1110 and the second panel 1120, a metallized substrate 4170 attached to and supported by a bottom surface of the intermediate panel 4130, and a strip 1140 of LEDs 1144 attached to and supported by the metalized substrate 4170. In various instances, one or more adhesives and/or fasteners are used to attach the metalized substrate 4170 to the intermediate panel 4130 and/or attach the strip 1140 to the intermediate panel 4130. The baffle 4100 further comprises a lens 4150 supported by the first panel 1110 and the second panel 1120. In the embodiment of FIG. 9, the first panel 1110 comprises a first longitudinal retention slot 4115 and the second panel 1120 comprises a second longitudinal retention slot 4125 which hold the lens 4150 in position. Notably, the first and second longitudinal retention slots 4115 and 4125 are different than the first and second longitudinal retention slots 1115 and 1125 depicted in FIG. 6. More specifically, the longitudinal retention slots 4115 and 4125 have a V-shaped configuration while the longitudinal retention slots 1115 and 1125 have a rectangular configuration. In various instances, the V-shaped configuration of the longitudinal retention slots 4115 and 4125 can accommodate various manufacturing tolerances of the components while holding the lens 4150 in a secure manner with little, if any, relative movement between the lens 4150 and the first and second panels 1110 and 1120. In various embodiments, the longitudinal retention slots can comprise a square and/or a circular configuration, for example.

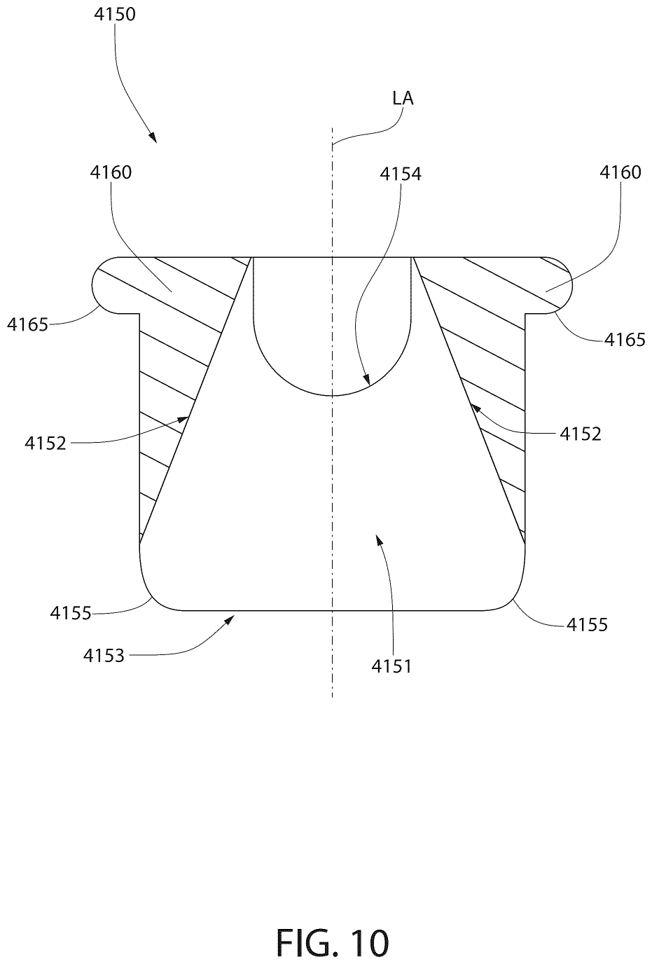

Further to the above, referring to FIGS. 9 and 10, the lens 4150 comprises a triangular-shaped lens body 4151 that extends longitudinally between a first longitudinal end and a second longitudinal end of the baffle 4100. The lens body 4151 includes a bottom surface 4153, rounded corners 4155 at the ends of the bottom surface 4153, and lateral sides 4152 extending upwardly and inwardly from the rounded corners 4155. Referring primarily to FIG. 10, the lateral sides 4152 of the lens body 4151 extend at an angle relative to a lens axis LA of the lens 4150. In various instances, each lateral side 4152 extends at a 20 degree angle relative to the lens axis LA, for example. In at least one instance, each lateral side 4152 extends at a 30 degree angle relative to the lens axis LA, for example. In other instances, each lateral side 4152 extends at an angle between 10 degrees and 40 degrees, for example, relative to the lens axis LA, for example. The above being said, the lens body 4151 can comprise any suitable configuration.

Referring again to FIGS. 9 and 10, the lens body 4151 further comprises a concave cavity 4154 defined in the backside thereof that faces toward the LEDs 1144 of the strip 1140 when the lens 4150 is attached to the first panel 1110 and the second panel 1120. To this end, the lens 4150 further comprises connectors 4160 mounted to opposite sides of the lens body 4151 which engage the first and second panels 1110 and 1120. Each connector 4160 is mounted to a lateral side 4152 of the lens body 4151 and comprises an angled surface that matches the angle of the lateral side 4152. The connectors 4160 are attached to the body 4151 in any suitable manner, such as by one or more adhesives, for example. Each connector 4160 comprises a retention shoulder 4165 that is received within one of the first and second retention slots 4115 and 4125 and, as a result of this arrangement, the lens 4150 is securely held in position between the first and second panels 4110 and 4120. Moreover, as a result of this arrangement, the lens 4150 is held securely against the strip 1140. With the lens 4150 positioned against the strip 1140, the lens 4150 and the strip 1140 define a longitudinal cavity 1190 therebetween that encloses the LEDs 1144 therein. As illustrated in FIG. 9, the LEDs 1144 are positioned in the concave cavity 4154 of the lens body 4151. The longitudinal cavity 1190 extends longitudinally along the length of the baffle 4100 and is enclosed at its longitudinal ends. The light emitted by the LEDs 1144 can travel within the longitudinal cavity 1190 and pass through the lens body 4151 at locations which may or may not be directly under the LEDs 1144. As a result of this arrangement, the presence of bright spots in the lens 1150 can be reduced. In other embodiments, each LED 1144 of the light strip 1140 can be positioned in its own discrete cavity in the lens body 4151. In such embodiments, the discrete cavities can be configured and arranged so as to diffuse the light emitted by the LEDs 1144 laterally, as well as downwardly, to reduce the presence of bright spots in the lens 1150.

Further to the above, the lens body 4151 is comprised of at least one diffuse transmission material. In various instances, the diffuse transmission material scatters light, for example, in many directions when light passes through it. Light entering into the lens 4150 can enter into the lens body 4151 in one direction, or a range of directions, and exit the lens body 4151 in a wide, or wider, range of directions. In various embodiments, the lens body 4151 is comprised of silicone, for example. In at least one embodiment, the lens body 4151 is comprised of frosted glass and/or plastic, such as polycarbonate, for example. The connectors 4160 are comprised of at least one white opaque material. In various instances, as illustrated in FIG. 9, light L emitted from the LEDs 1144 can enter into the lens body 4151, pass through the lens body 4151, and reflect off the connectors 4160 and back into the lens body 4151. In such instances, the light L can diffuse before it contacts the connectors 4160 and, also, after it contacts the connectors 4160 which can create greatly diffuse the light L and create a very aesthetic appearance, or glow, when exiting the lens body 4151 through the bottom surface 4153 and/or through the rounded corners 4155 of the lens body 4151. Notably, the connectors 4160 do not cover, or at least substantially cover, the rounded corners 4155 of the lens body 4151. As a result of this arrangement, diffused light can be emitted downwardly and/or laterally through the bottom surface 4153 and/or the rounded corners 4155. Also notably, the lens 4150 is secured in a position within the baffle 4100 such that the rounded corners 4155 at least partially, if not entirely, protrude downwardly from the bottom surfaces 1113 and 1123 of the first and second panels 1110 and 1120 such that the light passing generally downwardly and/or laterally outwardly through the rounded corners 4155 is not blocked or absorbed by the first and second panels 1110 and 1120. Moreover, as a result of this arrangement, the entirety of the bottom surface 4153 of the lens body 4151 is positioned below the bottom surfaces 1113 and 1123 of the first and second panels 1110 and 1120 and, as a result, light passing through the bottom surface 4153 is not blocked or absorbed by the first and second panels 1110 and 1120. As a result of the above, the lens 4150 comprises a diffuser configured to diffuse light generated by the baffle 4100 and create an aesthetically lit environment.

As described above in connection with the baffles 1100, 2100, and 3100, the lens 1150 thereof faces downwardly toward the floor when the baffles 1100, 2100, and 3100 are secured to, or suspended from, the ceiling. Similarly, the lens 4150 of the baffle 4100 faces downwardly toward the floor when the baffle 4100 is secured to, or suspended from, the ceiling. That said, the lens of a baffle can extend in any suitable direction. For instance, referring again to FIG. 1, the baffle 1100 could comprise a lens on the first lateral side 1102 and a lens on the second lateral side 1104. In such embodiments, the lens on the first lateral side 1102 and the lens on the second lateral side 1104 face in opposite directions. Moreover, in such embodiments, the lens on the first lateral side 1102 and the lens on the second lateral side 1104 could extend orthogonally to the lens 1150. In such embodiments, the strip 1140 of LEDs 1144 can extend around the first and second lateral sides 1102 and 1104 such that light emitted by the LEDs 1144 can pass through the side lenses. Such an arrangement can provide side lighting as well as downlighting. In addition to or in lieu of the side lenses and lights, the baffle 1100, for example, can comprise an upwardly-facing lens and a strip 1140 of LEDs 1144. Such an arrangement can provide uplighting in addition to or in lieu of downlighting. In various embodiments, the downwardly-facing LEDs 1144, the side-facing LEDs 1144, and the upwardly-facing LEDs 1144 of a baffle 1100 can be independently controlled by a controller, processor, or control system of the baffle 1100 in response to a control signal.

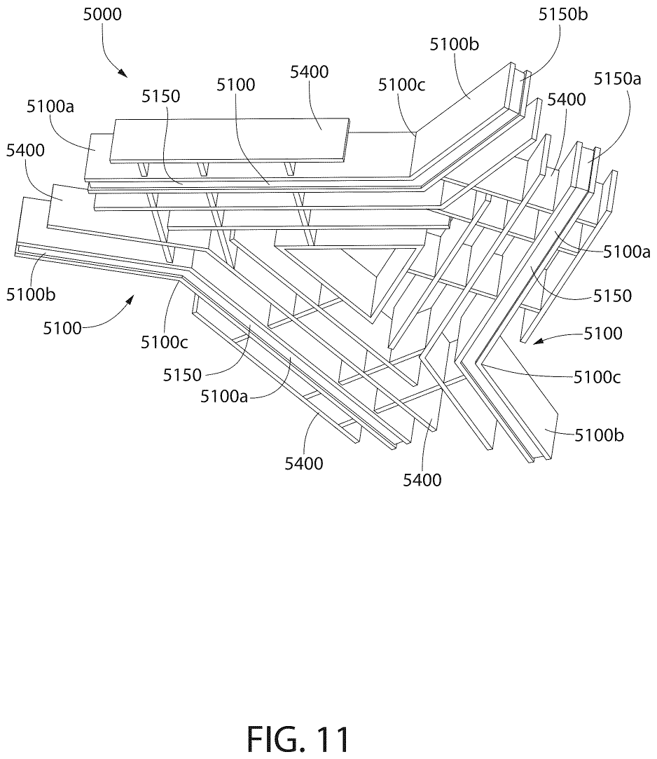

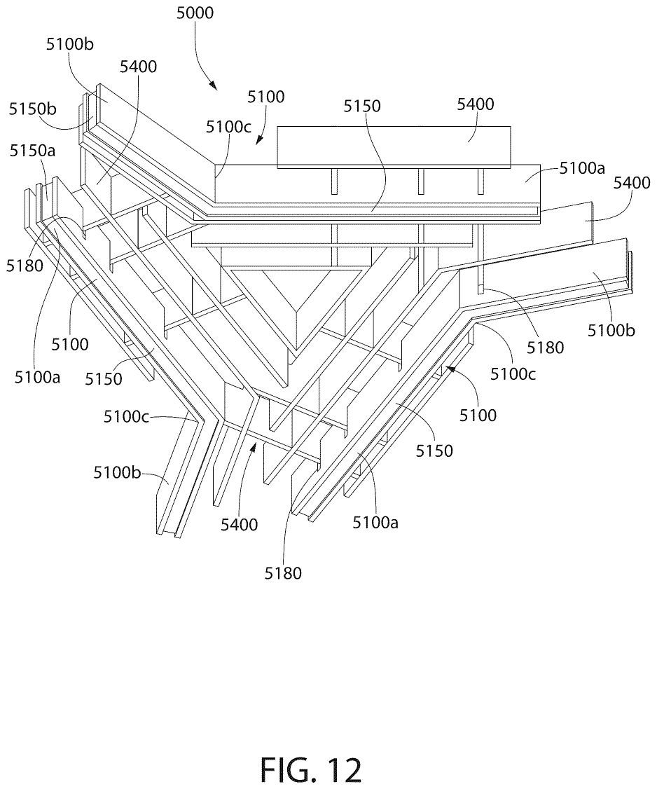

A baffle assembly 5000 is illustrated in FIGS. 11 and 12. The baffle assembly 5000 comprises structural baffles 5400 that create an aesthetic structure that is supported by, or suspended from, a ceiling of a building structure by cables and/or rods, for example. The structural baffles 5400 are comprised of felt, for example, but can be comprised of any suitable material. The structural baffles 5400, like the other baffles disclosed herein, are configured to absorb sound but they do not have a lighting system. Rather, they provide a frame or lattice work that supports lit baffles 5100. Similar to the baffles 1100, 2100, 3100, and 4100, each lit baffle 5100 comprises a lighting system. Moreover, each lit baffle 5100 comprises a first longitudinal section 5100a and a second longitudinal section 5100b that extend at an angle relative to one another and are connected at a vertex 5100c. That said, the lit baffles 5100 can comprise any suitable configuration, such as a curved configuration, for example. Further to the above, each lit baffle 5100 comprises downwardly-facing lights and a downwardly-facing lens 5150, laterally-facing lights and a first lateral lens 5150a on the distal end of its first longitudinal section 5100a, and laterally-facing lights and a second lateral lens 5150b on the distal end of its second longitudinal section 5100b. Notably, the first and second lateral lenses 5150a and 5150b face in different, but not opposite, directions. In various embodiments, the lit baffles 5100 can each comprise upwardly-facing lights and an upwardly-facing lens.

Further to the above, the lit baffles 5100 of the baffle assembly 5000 are secured to the structural baffles 5400 by friction-fit and/or press-fit interconnections. In various embodiments, the lit baffles 5100 are secured to the structural baffles 5400 by fasteners, such as by threaded bold/nut assemblies, for example. In various instances, the fasteners can be removed to adjust the position of the lit baffles 5100 relative to the structural baffles 5400. Upon comparing FIG. 11 and FIG. 12, it should be appreciated that the lit baffles 5100 in FIG. 12 are in a lower vertical position as compared to the lit baffles 5100 in FIG. 11. In embodiments utilizing fasteners, the structural baffles 5400 have vertical arrays of apertures defined therein that are configured to receive the fasteners and accommodate a plurality of pre-defined vertical positions of the lit baffles 5100 relative to the structural baffles 5400. Moreover, the lit baffles 5100 comprise adjustment slots 5180 defined therein that are configured to accommodate a plurality of vertical positions of the lit baffles 5100 relative to the structural baffles 5400. The sidewalls of the adjustment slots 5180 are configured to closely receive a structural baffle 5400 therein and limit, or at least substantially limit, relative movement between the lit baffles 5100 and the structural baffles 5400 to vertical movement therebetween. Once the lit baffles 5100 have been suitably positioned relative to the structural baffles 5400, the fasteners can be used to re-secure the lit baffles 5100 to the structural baffles 5400. In various embodiments, a friction-fit and/or press-fit is present between the sidewalls of the adjustment slots 5180 and the structural baffles 5400 which allows the lit baffles 5100 to be securely positioned and retained in a number of positions relative to the structural baffles 5400 without the use of fasteners. Such arrangements can allow the baffle assembly 5000 to be adjusted to suit different rooms and/or lighting preferences, for example.

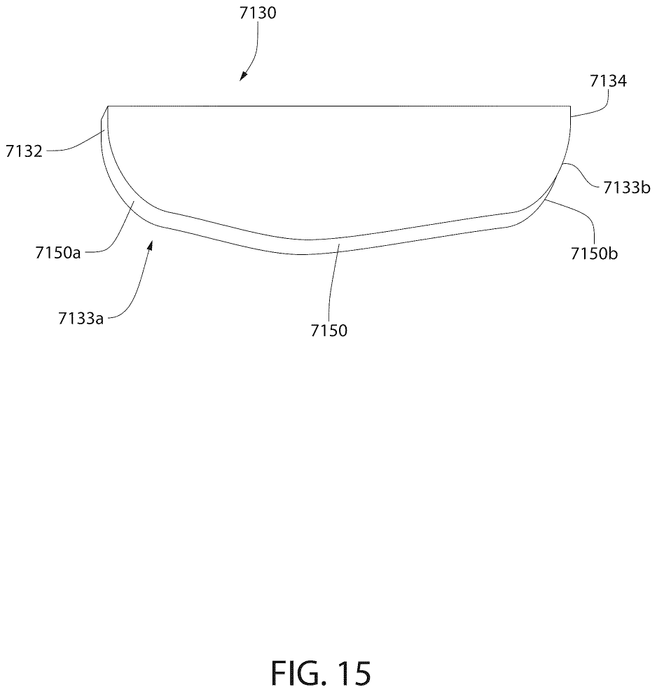

As described above, each lit baffle 5100 comprises a downwardly-facing lens 5150, a first laterally-facing lens 5150a, and a second laterally-facing lens 5150b. The lens 5150 extends along a longitudinal axis and the first laterally-facing lens 5150a extends along a transverse axis that is transverse to the longitudinal axis of the lens 5150. Similarly, the second laterally-facing lens 5150b extends along another transverse axis that is transverse to the longitudinal axis of the lens 5150. The first laterally-facing lens 5150a extends orthogonally relative to the lens 5150 at a first corner, but can extend at any suitable angle. Similarly, the second laterally-facing lens 5150b extends orthogonally relative to the lens 5150 at a second corner, but can also extend at any suitable angle. In various other embodiments, the lens of a baffle is curved. For instance, referring to FIG. 15, a baffle can comprise an intermediate panel 7130 comprising a curved bottom surface 7133 and a curved lens 7150 that matches the curved bottom surface 7133. Similar to the above, a strip 1140 of LEDs is mounted to the curved bottom surface 7133 such that some LEDs 1144 of the strip 1140 emit light downwardly, some LEDs 1144 emit light laterally from a first end 7132 of the intermediate panel 7130, and some LEDs 1144 emit light laterally from a second end 7134 of the intermediate panel 1130. The curved bottom surface 7133 comprises a first end portion 7133a that curves, or wraps, upwardly and around at least a portion of the first end 7132 and a second end portion 7133b that curves, or wraps, upwardly and around at least a portion of the second end 7134 such that light can be emitted laterally in the first and second directions from the first and second ends 7132 and 7134, respectively. The curved lens 7150 comprises a first end 7150a that curves upwardly with the first end portion 7133a and a second end 7150b that curves upwardly with the second end portion 7133b.

Referring to FIG. 13, a baffle assembly 6000, similar to the baffle assembly 5000, is comprised of structural baffles 5400 that create an aesthetic structure that is supported by, or suspended from, a ceiling of a building structure by cables and/or rods, for example. The baffle assembly 6000 further comprises lit baffles 6100 that are similar to the baffles 1100, 2100, 3100, 4100, and 5100 in many respects. Each baffle 6100 comprises a first panel 6110, a second panel 6120, and an intermediate panel 6130 positioned between the first panel 6110 and the second panel 6120. The intermediate panel 6130 comprises a bottom surface 6133 extending between a first end 6132 and a second end 6134 that is contoured. Referring to FIG. 14, the contour of the bottom surface 6133 comprises concave portions 6133a, convex portions 6133c, and inflection portions 6133b intermediate the concave portions 6133a and the convex portions 6133c. In various embodiments, the contour of the bottom surface 6133 is entirely curved while, in other embodiments, the contour of the bottom surface 6133 comprises one or more flat portions. Further to the above, a strip 1140 of LEDs can be mounted to the bottom surface 6133 of the intermediate panel 6130 such that the strip 1140 assumes a contour that matches the contour of the bottom surface 6133. In matching the contour of the bottom surface 6133, the contour of the strip 1140 can be identical to the contour of the bottom surface 6133 but it need not be; rather, a matching contour of the strip 1140 can be one that appears to an observer to be the same as the bottom surface 6133. The first panel 6110 comprises a bottom surface 6113 that matches the contour of the bottom surface 6133 of the intermediate panel 6130. Similarly, the second panel 6120 comprises a bottom surface 6123 that matches the contour of the bottom surface 6133 of the intermediate panel 6130. Similar to the above, a matching contour of the bottom surfaces 6113 and 6123 can be one that at least appears to an observer to be the same as the bottom surface 6133, but could be identical.

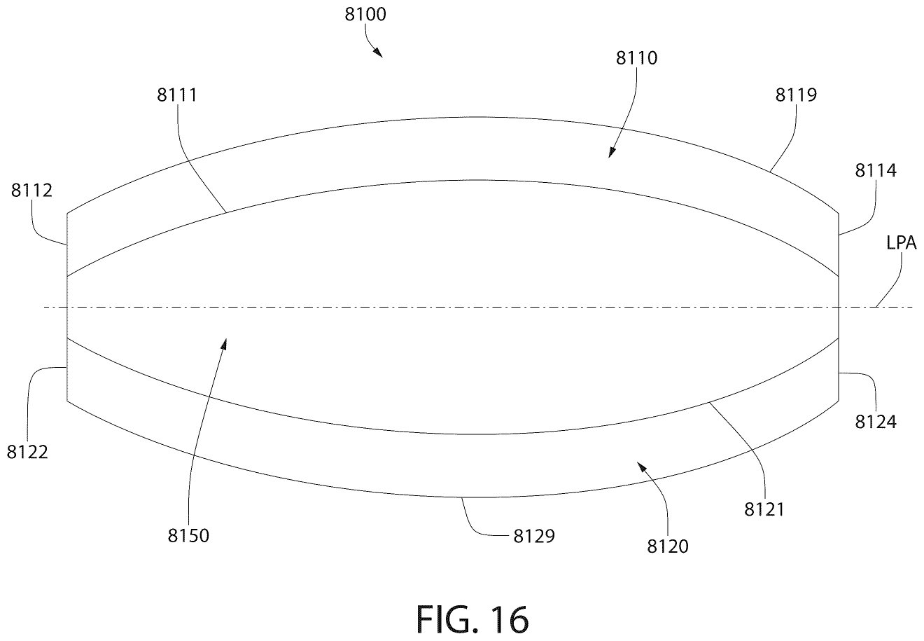

Referring again to FIGS. 1-6, the first panel 1110, the second panel 1120, and the intermediate panel 1130 of the baffle 1100 extend parallel, or at least substantially parallel, to one another. The panels 1110, 1120, and 1130 can be substantially parallel to one another when they appear parallel to an observer. In various instances, the first panel 1110 extends along a first longitudinal axis, the second panel 1120 extends along a second longitudinal axis, and the intermediate panel 1130 extends along a third longitudinal axis, where the first longitudinal axis, the second longitudinal axis, and the third longitudinal axis are parallel to one another. Referring to FIG. 16, a baffle 8100 comprises a first panel 8110 and a second panel 8120 that are not parallel to one another. The first panel 8110 is curved between a first end 8112 and a second end 8114 and comprises a curved inner sidewall 8111 and a curved outer sidewall 8119. Similarly, the second panel 8120 is curved between a first end 8122 and a second end 8124 and comprises a curved inner sidewall 8121 and a curved outer sidewall 8129. The first panel 8110 and the second panel 8120 are bowed outwardly with respect to a longitudinal panel axis LPA, but in opposite directions, which creates a canoe-like shape. The baffle 8100 further comprises an intermediate panel positioned intermediate the first panel 8110 and the second panel 8120, at least one strip 1140 of lights mounted to the intermediate panel, and a lens 8150 that extends between the first panel 8110 and the second panel 8120. The lens 8150 is wider in the middle than at its ends such that the cavity defined between the first and second panels 8110 and 8120 is completely covered by the lens 8150. In other embodiments, one or both of the first and second panels 8110 and 8120 can be bowed inwardly toward the longitudinal panel axis LPA, for example.

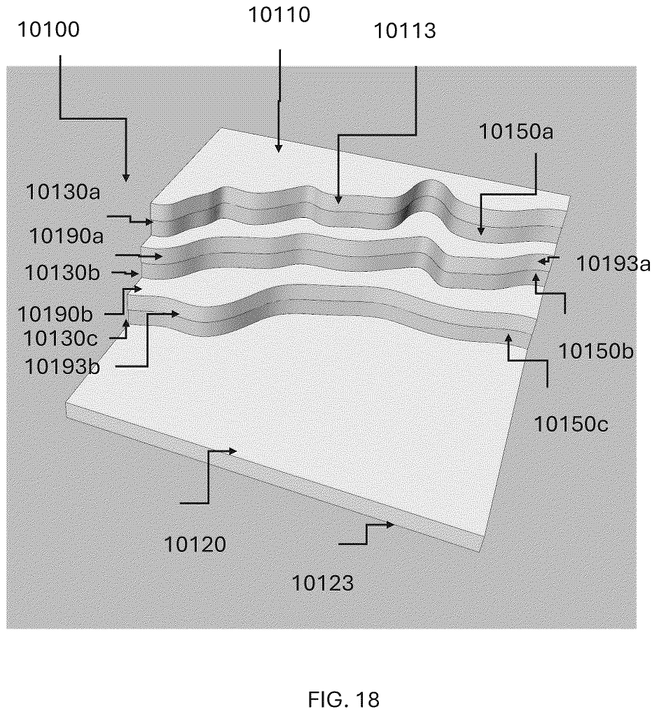

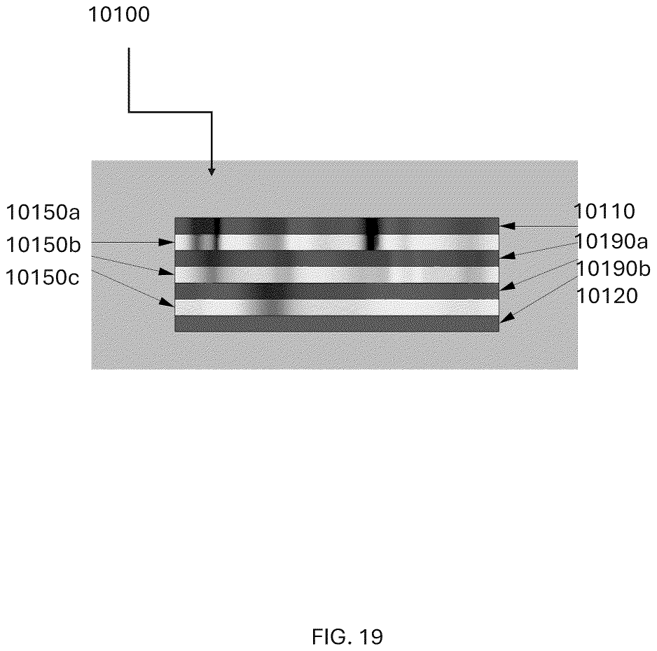

A ceiling baffle 10100 is illustrated in FIGS. 18 and 19. The baffle 10100 is similar to the baffles 1100, 2100, 3100, 4100, 5100, 6100, and 7100 in many respects. The baffle 10100 comprises a first outer panel 10110, a second outer panel 10120, and a plurality of intermediate panels positioned between the first outer panel 10110 and the second outer panel 10120. The intermediate panels comprise lit panels 10130a, 10130b, and 10130c that each have a strip 1140 of LEDs mounted thereto, for example, and non-lit panels 10190a and 10190b that do not have lights mounted thereto. Similar to the above, the panels 10110, 10120, 10130a, 10130b, 10130c, 10190a, and 10190b extend along parallel axes and are bonded together by one or more adhesives and/or one or more fasteners, for example. Referring to FIG. 18, the first outer panel 10110 has an undulating bottom surface 10113 and the second outer panel 10120 has a flat bottom surface 10123. That said, the first and second outer panels 10110 and 10120 can have any suitable bottom surfaces. The non-lit panels 10190a and 10190b also have undulating bottom surfaces 10193a and 10193b, respectively. That said, neither the contour of the bottom surface 10193a nor the contour of the bottom surface 10193b match the contour of the bottom surfaces 10113 and 10123 of the first and second outer panels 10110 and 10120, respectively. Rather, the contours of the bottom surfaces 10113, 10123, 10193a, and 10193b are all different.

Further to the above, the baffle 10100 further comprises three lenses - a first lens 10150a, a second lens 10150b, and a third lens 10150c. The first lens 10150a is aligned with the lit panel 10130a and is mounted to the first outer panel 10110 and the non-lit panel 10190a in any suitable manner, such as those disclosed herein, for example. Notably, the first lens 10150a has a contour that matches, or at least substantially matches, the contour of the bottom surface 10113 of the first outer panel 10110. Light emitted by the strip 1140 mounted to the lit panel 10130a is diffused by the first lens 10150a. The second lens 10150b is aligned with the lit panel 10130b and is mounted to the non-lit panel 10190a and the non-lit panel 10190b in any suitable manner, such as those disclosed herein, for example. Notably, the second lens 10150b has a contour that matches, or at least substantially matches, the contour of the bottom surface 10193a of the non-lit panel 10190a. Light emitted by the strip 1140 mounted to the lit panel 10130b is diffused by the second lens 10150b. The third lens 10150c is aligned with the lit panel 10130c and is mounted to the non-lit panel 10190b and the second outer panel 10120 in any suitable manner, such as those disclosed herein, for example. Notably, the third lens 10150c has a contour that matches, or at least substantially matches, the contour of the bottom surface 10193b of the non-lit panel 10190b. Light emitted by the strip 1140 mounted to the lit panel 10130c is diffused by the third lens 10150c. A contour of a lens can substantially match the contour of a bottom surface of a panel when it appears to match to an observer.

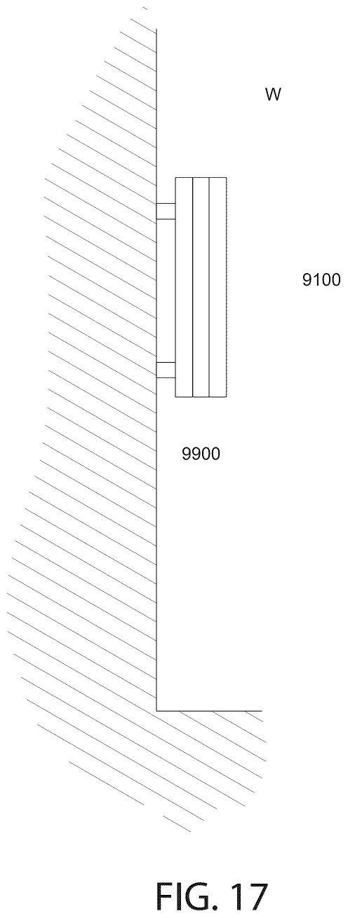

As described herein, the lighting system of a baffle can comprise a strip of LEDs that emits light diffused by a lens. In various embodiments, a baffle can comprise more than one strip of LEDs. In at least one such embodiment, various strips of LEDs can be controlled differently by a controller, processor, or control system. For instance, one strip can be controlled to have a first color and/or a first intensity and another strip can be controlled to have another color and/or intensity. Moreover, in at least one embodiment, the strip of LEDs and the lens can comprise an assembly that is inserted between the first and second panels of a baffle. Such an arrangement can facilitate the assembly of the baffle. Moreover, the teachings provided herein can also apply to a wall baffle, i.e., a baffle mounted to a wall, for example. FIG. 17 depicts a baffle 9100 mounted to a wall W via connectors 9900. The baffle 9100 is similar to the baffles 1100, 2100, 3100, 4100, 5100, 6100, 7100, 8100, and 10100 in many respects. Also, the teachings provided herein can apply to components integrally formed with a structure, for example.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A ceiling baffle, comprising:
a first panel;
a second panel;
a cavity defined between the first panel and the second panel, wherein the cavity is further defined by:
a support wall; and
an open end opposite the support wall;
a strip comprising light emitting diodes, wherein the strip is attached to the support wall; and
a lens engaged with the first panel and the second panel, wherein the lens is positioned intermediate the strip and the open end of the cavity.

2. The ceiling baffle of claim 1, further comprising an intermediate panel positioned intermediate the first panel and the second panel, wherein the intermediate panel comprises the support wall.

3. The ceiling baffle of claim 1 further comprising a first longitudinal end and a second longitudinal end, wherein the support wall extends between the first longitudinal end and the second longitudinal end along a longitudinal axis.

4.-9. (canceled)

10. The ceiling baffle of claim 1, further comprising:
a first reflective sheet attached to the first panel intermediate the strip and the lens; and
a second reflective sheet attached to the second panel intermediate the strip and the lens.

11. The ceiling baffle of claim 1, further comprising a metal substrate positioned intermediate the strip and the support wall.

12. (canceled)

13. The ceiling baffle of claim 1, wherein the lens comprises a diffused transmission material.

14. The ceiling baffle of claim 13, wherein the diffused transmission material comprises:
a bottom surface;
a first side surface; and
a second side surface, wherein the first side surface and the second side surface form a triangular shape.

15. The ceiling baffle of claim 14, further comprising a first connector attached to the first side surface of the diffused transmission material and a second connector attached to the second side surface of the diffused transmission material, wherein the first connector is engaged with the first panel, and wherein the second connector is engaged with the second panel.

16. The ceiling baffle of claim 15, wherein the first connector and the second connector are comprised of an opaque material, and wherein the diffused transmission material is comprised of silicone.

17. (canceled)

18. The ceiling baffle of claim 1, wherein the first panel comprises a first bottom surface and the second panel comprises a second bottom surface, and wherein the lens is recessed with respect to the first bottom surface and the second bottom surface.

19. The ceiling baffle of claim 1, wherein the first panel comprises a first bottom surface and the second panel comprises a second bottom surface, and wherein the lens extends downwardly with respect to the first bottom surface and the second bottom surface.

20. The ceiling baffle of claim 1, wherein the lens comprises a concave cavity defined in a backside thereof that faces the strip.

21. The ceiling baffle of claim 20, wherein at least a portion of the strip and at least a portion of each light emitting diode is positioned in the concave cavity.

22. (canceled)

23. The ceiling baffle of claim 1, wherein the first panel comprises a first retention slot, wherein the second panel comprises a second retention slot, and wherein the lens is positioned in and retained between the first retention slot and the second retention slot.

24.-26. (canceled)

27. The ceiling baffle of claim 3, wherein the cavity is further defined by a second open end at the first longitudinal end and a third open end at the second longitudinal end, and wherein the ceiling baffle further comprises:
a second lens engaged with the first panel and the second panel, wherein the second lens is positioned intermediate the strip and the second open end of the cavity; and
a third lens engaged with the first panel and the second panel, wherein the third lens is positioned intermediate the strip and the third open end of the cavity.

28. The ceiling baffle of claim 1, wherein the cavity is further defined by a second open end at a first longitudinal end of the ceiling baffle and a third open end at a second longitudinal end of the ceiling baffle, and wherein the ceiling baffle further comprises:
a second lens engaged with the first panel and the second panel, wherein the second lens is positioned intermediate the strip and the second open end of the cavity; and
a third lens engaged with the first panel and the second panel, wherein the third lens is positioned intermediate the strip and the third open end of the cavity.

29. The ceiling baffle of claim 1, wherein the first panel comprises a first enclosure defined by walls comprised of felt, and wherein the second panel comprises a second enclosure defined by walls comprised of felt.

30. The ceiling baffle of claim 1, further comprising a second strip comprising light emitting diodes, wherein the second strip is attached to the support wall.

31. A baffle, comprising:
a first wall;
a second wall;
a chamber defined between the first wall and the second wall, wherein the chamber is further defined by:
a back wall; and
an opening opposite the back wall;
an arrangement of light emitting diodes, wherein the arrangement of light emitting diodes is supported by the first wall and the second wall; and
a diffusion plate positioned intermediate the first wall and the second wall, wherein the diffusion plate is positioned intermediate the arrangement of light emitting diodes and the opening.

32.-36. (canceled)

37. A baffle, comprising:
a first wall;
a second wall;
a chamber defined between the first wall and the second wall;
a light assembly; and
a diffuser positioned intermediate the first wall and the second wall, wherein the diffuser is positioned intermediate the light assembly and the opening.

38.-43. (canceled)
